(19) United States
(12) Patent Application Publication
(10) Pub. No.: US 2007/0243969 A1
(43) Pub. Date: Oct. 18, 2007

(54) Continuously-Variable Non-Slip Transmissions

(76) Inventor: Ran Siman-Tov, Tel Aviv (IL)

Correspondence Address: Martin D. Moynihan, P.O.Box 16446, Arlington, VA, 22215, US

(21) Appl. No.: 11/597,820

(22) PCT Filed:
(86) PCT No.: PCT/IL05/00541

(30) Foreign Application Priority Data
May 27, 2004 (IL) 162179
Mar. 24, 2005 (IL) 167662

(51) Int. Cl. F16H 37/06

(52) U.S. Cl. 476/5

(57) ABSTRACT

A continuously-variable transmission includes a pair of axially-displaceable rotary members which are rotatable together about a rotary axis and carry a plurality of coupling elements radially displaceable with respect to the rotary axis to define an effective coupling surface of circular configuration having a diameter varying with the radial positions of the coupling elements. A closed loop link chain is wound around the effective coupling surface of the rotary members and carries a plurality of coupling elements effecting a non-slip coupling with the coupling elements of the rotary members. The rotary members have outer conical surfaces, and the closed loop link chain has contact surfaces bearing against the outer conical surfaces of the rotary members for continuously supporting the closed loop in the circular configuration of the effective coupling surface of the rotary members where wound around the rotary members.

### FIELD AND BACKGROUND OF THE PRESENT INVENTION

The present invention relates to continuously-variable transmissions. The invention is particularly useful in, and is therefore described below with respect to, the non-slip type of continuously-variable transmission described in International Patent Application PCT/IL02/00075, published Aug. 8, 2002, as International Publication No. WO 02/061306, assigned to the same assignee as the present application, and the contents of which are incorporated herein by reference.

The above-cited Patent Application No. PCT/IL02/00075, discloses a number of non-slip type variable type transmissions including some broadly comprising: a first transmission unit including a rotary member rotatable about a rotary axis, and a plurality of circumferentially-spaced coupling elements carried by the rotary member and radially displaceable with respect to the rotary axis to define an effective coupling surface of circular configuration having a diameter varying with the radial positions of the coupling elements; and a second transmission unit including a closed loop wound around the effective coupling surface of the first transmission unit and carrying a plurality of longitudinally-spaced coupling elements engageable with the coupling elements of the first transmission unit to effect a non-slip coupling therewith;

Such constructions provide a limited number of contact points between the closed loop (e.g. belt, chain, etc.) and the coupling elements of the first transmission unit, and therefore the closed loop takes the shape of a polygon where wound around the coupling elements of the first transmission unit. Such a polygonal shape of the closed loop, and its engagement by coupling elements at the junction of each side of the polygon, produce a non-uniform tension in the closed loop, in that the closed loop is tensioned more at one side of the engaged coupling elements than at the other side. In addition, such a polygonal shape of the closed loop causes the closed loop to engage the coupling elements of the first transmission unit in a non-tangential approach, which also unduly strains the closed loop. Such problems increase as the diameter of the first transmission unit increases, or as the number of coupling points decreases, since in both cases the distance between the coupling points increases. Accordingly, a larger number of such coupling elements would be required to reduce this problem.

An additional problem encountered in many of the known continuously-variable transmissions is in the manner of changing the diameter of the effective coupling surface under pressure. In a typical continuously-variable transmission including axially-spaced conical members and a V-belt coupled thereto, the diameter is changed by axial pressure applied to the spaced conical members. This becomes problematic when the speed is low, when the torque is high, and when the cone slopes are steeper. For example, in a bicycle application of such a transmission, the available space limits the width of the cones and therefore necessitates steep slopes. High axial forces are thereby required to move the cones toward each other.

A further problem encountered in many transmissions, particularly those including a closed-loop link chain, is the difficulty of assuring precise engagement of the coupling elements with the link chain. Thus, if the coupling elements are not precisely aligned with the pins of the link chain at the instant of engagement, there is a danger of jamming, and also a danger of creating substantial noise.

### OBJECT AND BRIEF SUMMARY OF THE PRESENT INVENTION

An object of the present invention is to provide a continuously-variable transmission having advantages in one or more of the above respects, as will be described more particularly below.

According to one aspect of the present invention, there is provided a continuously-variable transmission, comprising: a first transmission unit including a rotary member rotatable about a rotary axis, and a plurality of circumferentially-spaced coupling elements carried by the rotary member and radially displaceable with respect to the rotary axis to define an effective coupling surface of circular configuration having a diameter varying with the radial positions of the coupling elements; and a second transmission unit including a closed loop wound around the effective coupling surface of the first transmission unit and carrying a plurality of longitudinally-spaced coupling elements engageable with the coupling elements of the first transmission unit to effect a non-slip coupling therewith; characterized in that the rotary member of the first transmission unit has an outer surface which is conical or substantially conical; and in that the closed loop of the second transmission unit further includes contact surfaces bearing against the outer conical surface of the first transmission unit where wound therearound for continuously supporting the closed loop in the circular configuration of the effective coupling surface of the first transmission unit.

According to further features in the preferred embodiments of the invention described below, the first transmission unit includes a pair of rotary members axially-spaced from each other and axially-displaceable towards and away from each other to vary the diameter of the effective coupling surface, each of the rotary members having an outer conical surface against which the contact surfaces of the closed loop of the second transmission unit bear for continuously supporting the closed loop in the circular configuration of the effective coupling surface of the first transmission unit.

As will be described more particularly below, such a construction enables the closed loop (e.g. a chain, a belt, etc.) to preserve a circular, rather than a polygonal, configuration even where there are a small number of coupling points between the coupling elements of the two transmission units. Such a construction thus produces more uniform tension in the closed loop, and also reduces the number of coupling points that are required between the two transmission units. It further enables change of diameter to be more readily made, even under high torque, low speed, and steeper conical angles between the spaced rotary members.

According to further features in the preferred embodiments of the invention described below, the coupling elements of one of the transmission units are of a fixed configuration, and the coupling elements of the other transmission unit are of a self-adaptive configuration; that is, they are self-adaptive to the fixed configuration coupling elements in all radial positions of the coupling elements of the first transmission unit. In the described preferred embodiments, the coupling elements of the first transmission unit are of the self-adaptive configuration, and the coupling elements of the second transmission unit are of the fixed configuration.

According to another aspect of the present invention, there is provided a continuously-variable transmission, comprising: a first transmission unit including a pair of axially-spaced rotary members rotatable together about a rotary axis, the rotary members being axially displaceable towards and away from each other, and carrying a plurality of circumferentially-spaced coupling elements radially displaceable with respect to the rotary axis to define an effective coupling surface having a diameter varying with the axial spacing between the rotary members; and a second transmission unit carrying a plurality coupling elements engageable with the coupling elements of the first transmission unit to effect a non-slip coupling therewith; characterized in that the coupling elements of the first transmission unit are each carried by a mounting plate radially displaceable towards and away from the rotary axis to vary the diameter of the effective coupling surface; and in that the first transmission unit further includes actuator plates selectively actuatable to engage the mounting plates sequentially during the rotation of the first transmission unit, and to displace them towards or away from the rotary axis to thereby change the diameter of the effective coupling surface of the first transmission unit.

As will be described more particularly below, such an arrangement for changing the axial distance between the conical members in order to change the conversion ratio can be conveniently effected even with cones having relatively steep slopes, e.g. as required in a bicycle transmission because of the limited space available.

According to a still further aspect of the present invention, there is provided a transmission comprising: a first transmission unit including a rotary member rotatable about a rotary axis and having a plurality of circumferentially-spaced coupling elements carried thereby to define an effective coupling surface of circular configuration; and a second transmission unit including a closed loop link chain wound around the rotary member and having a plurality of transversely-extending pins engageable with the coupling elements of the rotary member to effect a non-slip coupling therewith; the coupling elements of the rotary member being movably mounted thereon so as normally to occupy an initial position with respect to the link chain, but movable to a coupling position, in precise alignment with the transversely-extending pins of the link chain, as or after the link chain makes tangential contact with the effective coupling surface of the first transmission unit.

As will also be described more particularly below, such an arrangement better assures precise engagement of the coupling elements with the link chain, to thereby reduce the possibility of jamming, or the creation of noise.

Further features and advantages of the invention will be apparent from the description below.

### BRIEF DESCRIPTION OF THE DRAWINGS

The invention is described herein, by way of example only, with reference to the accompanying drawings, wherein

FIGS. 1 and 2 are isometric and “transparent” side views, respectively, illustrating one form of continuously-variable transmission constructed in accordance with the present invention;

FIGS. 3 and 4 illustrate the coupling elements in the two transmission units in the continuously-variable transmission of FIGS. 1 and 2;

FIGS. 5a-5e illustrates various positions of the coupling elements in the two transmission units of FIGS. 3 and 4 during a cycle of operation of the transmission;

FIG. 6 illustrates another construction of link chain which may be used in the closed loop transmission unit;

FIGS. 7, 8 and 9 are isometric, side and end views respectively, illustrating another construction of self-adaptive coupling element that may be used in the transmission of FIGS. 1 and 2;

FIGS. 10 and 11 illustrate a still further construction of self-adaptive coupling element that may be used in the transmission of FIGS. 1 and 2;

FIGS. 12 and 13 are “transparent” side and isometric views, respectively, illustrating one manner of varying the transmission ratio of the transmission of the FIGS. 1 and 2;

FIGS. 14, 15 and 16 are fragmentary views illustrating various fixing mechanisms for fixing and releasing the coupling elements in the first transmission unit for movement to produce a desired diameter in the effective coupling surface;

FIG. 17 is an isometric view illustrating an implementation of the mechanism of FIG. 16;

FIG. 18 illustrates an arrangement that may be used for better assuring precise engagement of the coupling elements of the one transmission unit with respect to the closed loop of the second transmission unit at the initial point of contact between the two;

FIGS. 19a and 19b illustrate the initial and coupling positions, respectively, of the coupling elements of FIG. 18;

FIG. 20 illustrates another arrangement that may be used for better assuring precise engagement of the coupling elements of the one transmission unit with respect to the closed loop of the second transmission unit at the initial point of contact between the two;

FIG. 21 illustrates the mechanism for moving the coupling elements in FIG. 20 to their initial and coupling positions, respectively;

FIGS. 22a and 22b illustrate the initial and coupling positions of the coupling elements of FIGS. 20 and 21;

and

FIGS. 23, 24 and 25 are isometric, “transparent” side, and top plan views, respectively, illustrating a compact continuously-variable transmission constructed in accordance with the present invention.

It is to be understood that the foregoing drawings, and the description below, are provided primarily for purposes of facilitating understanding the conceptual aspects of the invention and possible embodiments thereof, including what is presently considered to be a preferred embodiment. In the interest of clarity and brevity, no attempt is made to provide more details than necessary to enable one skilled in the art, using routine skill and design, to understand and practice the described invention. It is to be further understood that the embodiments described are for purposes of example only, and that the invention is capable of being embodied in other forms and applications than described herein.

### DESCRIPTION OF PREFERRED EMBODIMENTS OF THE INVENTION

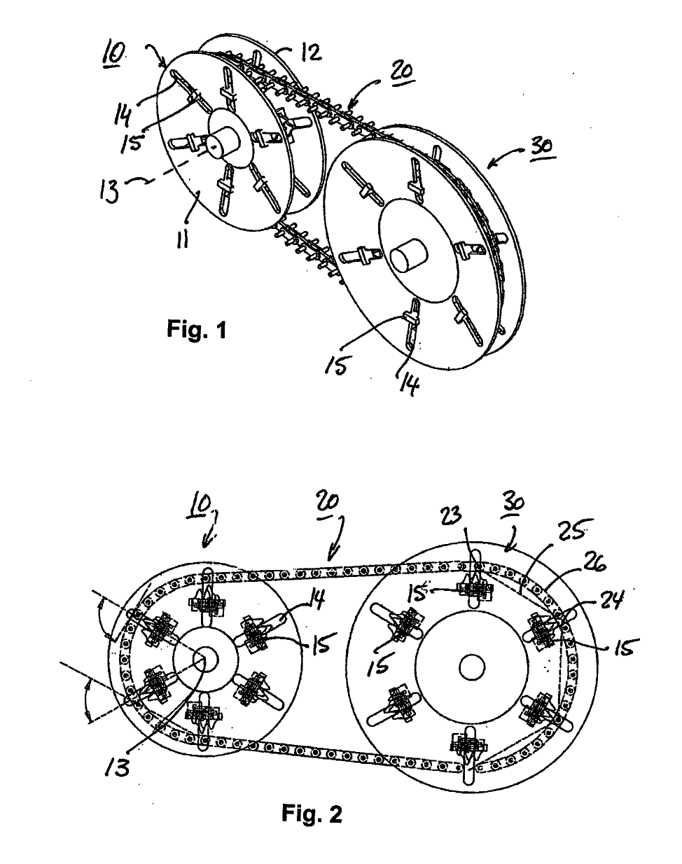

### The Embodiment of FIGS. 1-5

FIGS. 1 and 2 illustrate one form of continuously-variable transmission constructed in accordance with the present invention including a first transmission unit 10 coupled by a second transmission unit 20 to a third transmission unit 30. The second transmission unit 20 is of the closed loop type, whereas transmission units 10 and 30 are of the varying-diameter type. In this case, the two transmission units 10 and 30 are of similar construction, except that whereas the diameter of transmission unit 10 increases, that of transmission unit 30 decreases, and vice versa. Accordingly, only the construction and operation of transmission units 10 and 20 (or 30) are described below.

Transmission unit 10 includes a pair of axially-spaced rotary members 11, 12, rotatable together about a rotary axis 13. The confronting outer faces of the two rotary members 11, 12 are of conical configuration. The two rotary members are axially displaceable towards and away from each other, e.g., by moving one with respect to the other to define an effective coupling surfaces of circular configuration having a diameter varying with the axial spacing between the two members.

The two conical members 11, 12 are formed with a plurality of radially-extending slots 14 for receiving a plurality of circumferentially-spaced coupling elements, shown at in FIG. 1, and more particularly illustrated in FIG. 4. Coupling elements 15 are displaceable in the radial direction in their respective slots 14 so as to define an effective coupling surface with the closed loop transmission unit 20. The effective coupling surface defined by coupling elements 15 is of circular configuration and has a diameter varying with the radial position of the coupling elements with respect to the rotary axis 13, and thereby with the axial spacing between the two rotary members 11, 12.

As shown in FIG. 4, each coupling element 15 carried by transmission unit 10 includes a mounting plate 16 formed with a pair slots 17 adjacent each of its opposite ends. Slots 17 receive the edges of the radial slots 14 formed in the two conical members 11, 12, such that the mounting plates 16 are carried by and between the two conical members 11, 12, and are displaceable in their radial slots 14 towards or away from the rotary axis 13.

Each of the coupling elements 15 of transmission unit 10 is of a self-adaptive configuration enabling it to self-adapt to the fixed configuration of the coupling elements of the closed loop of transmission unit 20, and to produce a non-slip coupling with coupling elements in the closed loop in all radial positions of coupling elements 15 with respect to transmission unit 10. Various arrangements for providing such a non-slip coupling between coupling elements of a self-adaptive configuration on one transmission unit and coupling elements of a fixed configuration on the other transmission unit are described in the above-cited International Patent Application No. PCT/IL02/00075. FIGS. 4 and 5, described below, illustrate one such arrangement, called a “see-saw” arrangement.

As indicated earlier, transmission unit 30 is of similar construction as transmission unit 10, except that its radially-displaceable coupling elements 15 are moved in opposite directions from those in transmission unit 10, such that, as the effective diameter of transmission unit 10 increases, that of transmission unit 10 decreases, and vice versa.

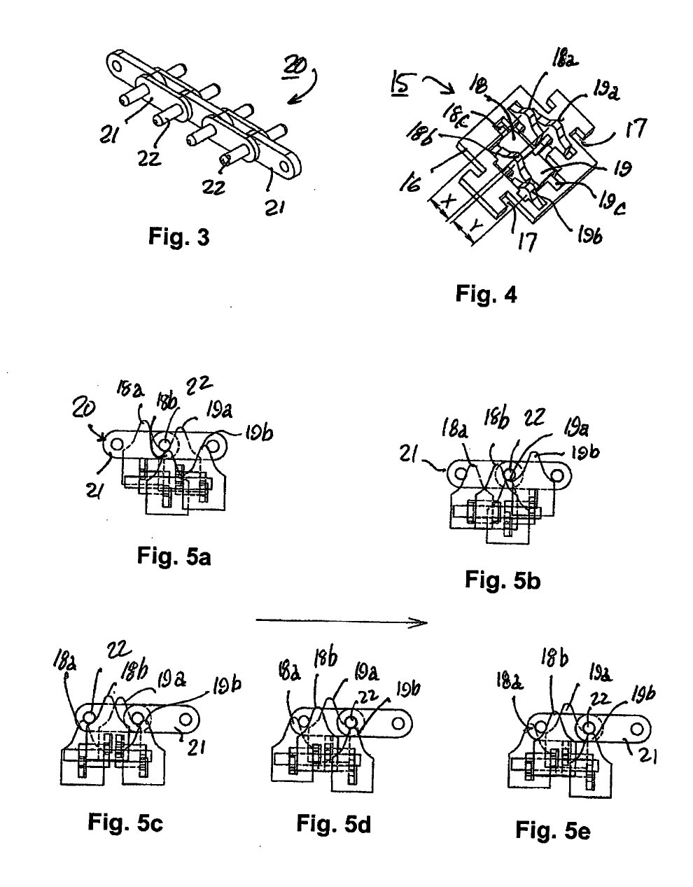

Transmission unit 20 coupling together transmission units 10 and 30 is in the form of a closed-loop link chain effective to produce a non-slip coupling with coupling elements 15 of transmission units 10 and 30. One construction of a link chain, as illustrated in FIG. 3, includes a plurality of links 21 pivotally coupled to each other by a plurality of transversely-extending pins 22. In this example, the links 21 occupy the center region of the link chain 20, and the pins 22 project outwardly from the links on the two opposite sides of the links. As described below, the pins 22 define a plurality of projections spaced by depressions (the space between the pins) sequentially engageable by each coupling element 15 carried by the two transmission units 10, 30, to effect a non-slip coupling between link chain 20 and each of the transmission units 10, 30, in all effective diameters of transmission units 10, 30.

Thus, as shown in FIG. 4, mounting plate 16 of each coupling element 15 includes a pivotal member 18 carrying two teeth 18a, 18b and is pivotted to mounting plate 16 about axis 18c, such that when tooth 18a descends, tooth 18b rises, and vice versa. Each mounting plate 16 includes a second pivotal member 19 similarly carrying two teeth 19a, 19b. Member 19 is pivotal about axis 19c, aligned with axis 18c, so that the two teeth 19a, 19b also move in opposite directions about the same axis as teeth 18a, 18b. The center lines of teeth 18a and 18b are spaced circumferentially by the distance “X”. The center lines of teeth 19a, 19b are similarly spaced the distance “Y”, equal to the distance

The distances “X” and “Y” between the center lines of the teeth in each pair are calculated such that the transversely-extending pins 22 of link chain 20 define projections (the pins) alternating with depressions (the spaces between the pins) of a fixed configuration sequentially engageable with projections (teeth 18a, 18b, 19a, 19b) and depressions (the spaces between the teeth) of a self-adaptive configuration of the coupling elements 15, and such that in any rest point of the link chain 20 with respect to the coupling elements 15, the ends of at least one of the pins 22 is always in contact with a rising slope of one of the teeth 18a, 18b, 19a, 19b.

Such an arrangement thereby provides a non-slip coupling between the pins 22 of transmission unit 20, and the teeth of transmission unit 10 in all radial positions of coupling elements 15 on transmission unit 10. In addition, the undersurface of the link chain 20 continuously engages the outer conical surfaces of the two rotary members 11, 12 of the two transmission units 10, 30; accordingly, the closed loop of transmission unit 20 is continuously supported in the circular configuration of the effective coupling surface of transmission units 10, 30, in all radial positions of coupling members 15 with respect to transmission units 10 and 30.

The foregoing is more clearly seen in FIG. 2, wherein it will be seen that link chain 20 engages the first coupling element 15 at coupling point 23 of transmission unit 30 and the second coupling element 15 at coupling point 24 of the transmission unit. Thus, if the conical surfaces of the two rotary members 11, 12 were not present, the link chain 20 would assume a polygonal configuration where wound around transmission unit 30, having a number of sides indicated at 25, corresponding to the number of coupling elements 15 in the portion of transmission unit 30 engaged by the link chain. As mentioned earlier, such a polygonal configuration of the link chain would produce non-uniform tensions therein. Thus, where link chain 20 drives the transmission unit 30, the tension would be high at the upstream side of the coupling point, and low at the downstream side of the coupling point. To minimize this non-uniformity in tension, the transmission unit would require a large number of coupling elements to decrease the length of each side of the polygon in order to approach a circular configuration.

However, when the underside of the link chain 20 bears against the outer conical surfaces of the two rotary members 11, 12 as described above, the link chain is supported substantially continuously in a circular configuration by such conical surfaces. This is clearly shown by curved section 26 of the link chain between the two coupling points 23 and 24. Such a construction thus produces a substantially uniform tension on the link chain where wound around the transmission unit even though a relatively few number of coupling elements 15 are provided to produce the non-slip coupling between the two transmission units.

In addition, and as also shown in FIG. 2, the link chain 20 effects a more precise tangential engagement with the effective circular coupling surface defined by coupling elements 15 of transmission unit 30. That is, when the link chain first engages the coupling elements 15 of transmission unit 30, this being at coupling point 23 in FIG. 2, the link chain is substantially perpendicular to the teeth 18a, 18b, 19a, 19b of the coupling elements. The latter teeth are radially aligned with the rotary axis of transmission unit 30, and are oriented substantially perpendicularly to the link chain, thereby producing an efficient transmission of power between the two transmission units and more uniformity in the stress applied to the chain link.

Preferably, each coupling element 15 is provided with two pairs of teeth 18a, 18b and 19a, 19b, as described above, in order to better assure a non-slip coupling between the two transmission units in all radial positions of the coupling elements 15. FIG. 5 illustrates a typical sequence of movements of the teeth 18a, 18b and 19a, 19b to sequentially engage pins 22 of link chain 20 in all radial positions of the coupling element 15 of transmission units 10 and 30. It will be seen from the sequence of steps (a)-(e) of FIG. 5, that at each position of the link chain, at least one pin 22 is in contact with a rising surface of a tooth, thereby effecting a non-slip coupling between the link chain and the teeth. The coupling elements 15, including their teeth 18a-19b, also assure that when the link chain 20 engages and applies a radial pressure to the coupling elements 15, the coupling elements will be restrained from swiveling, whereas when the link chain is not in engagement with the coupling elements, the coupling elements may swivel freely.

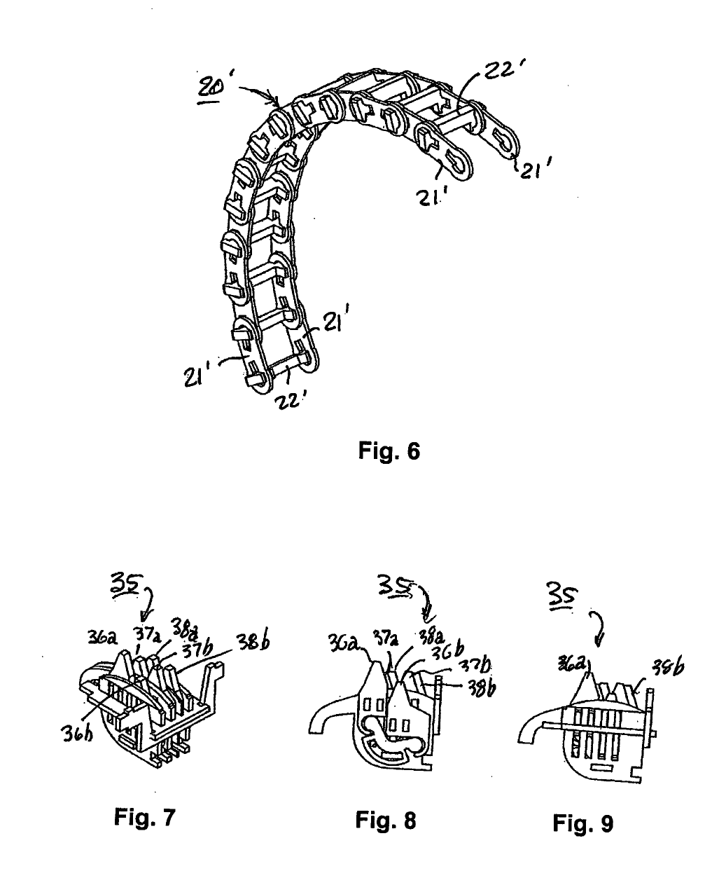

The Modification of FIGS. 6-9

FIG. 6 illustrates a variation in the construction of the link chain, therein generally designated 20′, wherein the links 21′ occupy the outer sides of the link chain, and the transversely-extending pins 22′ occupy the center region of the link chain, similar to a conventional link chain.

FIGS. 7-9 illustrate a construction of the coupling elements, therein generally designated 35, to be carried by the first transmission unit and to effect a non-slip coupling with link chain 20′ of FIG. 6. As seen in FIGS. 7-9, coupling unit 35 includes three pairs of teeth 36a, 36b; 37a, 37b; and 38a, 38b, respectively, cooperable with the transversely-extending pins 22′ of link chain 20′ to effect a non-slip coupling between the two transmission units in the manner described above.

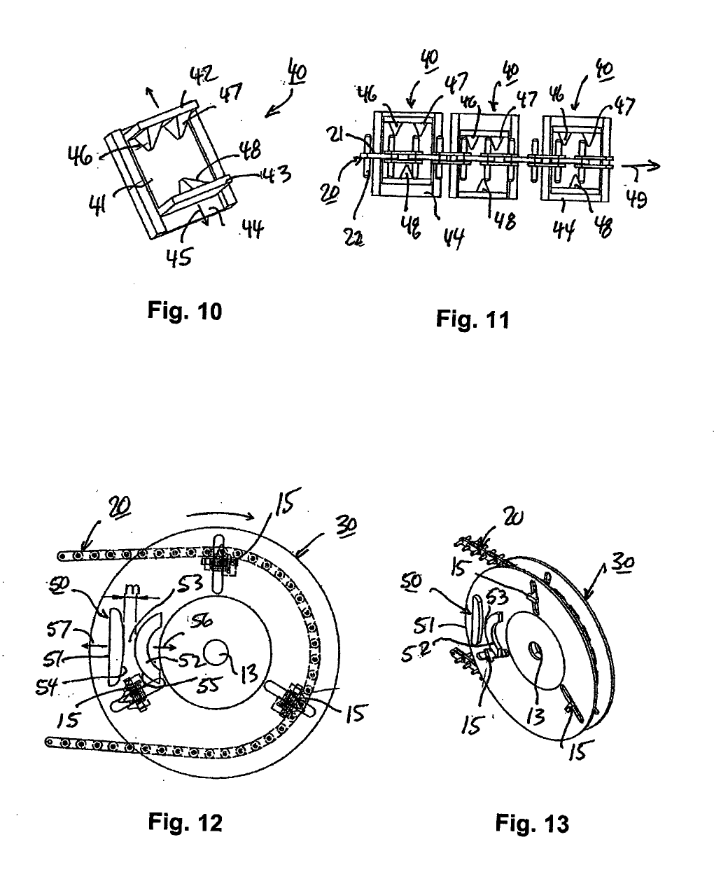

The Modification of FIGS. 10 and 11

FIGS. 10 and 11 illustrate another construction of coupling elements, therein generally designated 40, which can be used for the coupling elements 15 of the rotary transmission units 10 and 30 of FIGS. 1 and 2, or coupling elements 115 of FIGS. 7-9. Coupling elements 40 of FIGS. 10 and 11 are also of a self-adaptive construction enabling them to automatically self-adapt to the fixed configuration of the coupling elements of link chain 20.

Thus, each of the coupling elements 40 of FIGS. 10 and 11 is also radially displaceable on the respective transmission unit. It carries a mounting plate 41 of a U-shaped configuration to define two upstanding legs 42, 43 at its opposite ends. U-shaped plate 41 is slidable within a track 44 in the axial direction, as shown by arrow 45, in the respective coupling element 40. One upstanding leg 42 is integrally formed with a pair of spaced teeth 46, 47, and the other leg 43 is formed with a third tooth 48 aligned with the space between the two teeth 46, 47. All three teeth 46, 47, 48, are formed with inclined side faces for smooth engagement with pins 22 of link chain 20, as shown particularly in FIG. 11.

As also shown in FIG. 11, link chain 20 is received over coupling elements 40 such that the links 21 occupy the center region of the coupling elements, and the pins 22 project outwardly on opposite sides so as to be engageable with teeth 46, 47 on one side, and with tooth 48 on the opposite side. Thus, as the coupling elements 40 move in the direction of arrow 49 in FIG. 11, pins 22 of link chain 20 sequentially engage the teeth 46, 47 on one side, and tooth 48 on the opposite side, to thereby shift plate 41 back and forth within track 44.

Such a construction, therefore, also adapts the outer configuration of coupling elements 40 to the fixed configuration of coupling elements 22 of link chain 20 in all radial positions of coupling elements 40, as described above.

It will be appreciated that this construction can also be implemented with a chain similar to that illustrated it FIG. 6.

The Transmission-Ratio Changing Mechanism of FIGS. 12-17

FIGS. 12 and 13 illustrate a transmission-ratio changing mechanism which may be used to displace the coupling elements, e.g. 15, FIGS. 1-5, radially in order to change the conversion ratio during the operation of the transmission. Such a transmission-ratio changing mechanism is generally designated 50 in FIGS. 12 and 13. For simplification purposes, FIGS. 12 and 13 illustrate only one of the variable-diameter transmission units, namely unit 30, carrying only three radially-displaceable coupling elements 15. It will be appreciated, however, that the other transmission unit (10, FIG. 1) would be similarly equipped with a conversion-ratio changing mechanism, but operating in the reverse direction from that illustrated in FIG. 12, and that a different number of coupling elements could be used in such transmission units.

Thus, as shown in FIGS. 12 and 13, the transmission-ratio changing mechanism 50 includes two actuator plates 51, 52 located laterally of the rotary axis 13 of transmission unit 30 and spaced from each other to define a guiding slot 53 between them for engagement with the ends of the coupling elements 15 during the rotation of the transmission unit. Each of the actuator plates 51, 52 is of a curved configuration, to define converging surfaces 54, 55, on each of the opposite sides of guiding slot 53, so as to engage the ends of the coupling elements 15 and to smoothly guide them through the guiding slot 53 during the rotation of the transmission unit 30.

The two actuator plates 51, 52 are selectively movable together towards the rotary axis 13 (as shown by arrow 56), or away from the rotary axis (as shown by arrow 57). When the actuator plates are moved in the direction of arrow 56, they displace the coupling elements 15 radially towards the rotary axis to decrease the diameter of the effective coupling surface defined by coupling elements 15; and when the actuator plates 51, 52 are moved in the direction of arrow 57, they displace the coupling elements 15 away from the rotary axis to increase the diameter of the effective coupling surface on the transmission unit 30. Since the coupling units 15 are of fixed length, their radial displacement in either direction produces a corresponding change in the axial spacing between the two conical members (e.g. 11, 12, FIG. 1) of the respective transmission unit.

It is to be noted that the transmission-ratio changing mechanism 50 is located on the unloaded side of the rotary axis 13 of transmission unit 30, i.e., the side opposite to that engaged by the link chain 20. It is also to be noted that each of the coupling elements 15 is sequentially engaged and displaced a relatively short distance by the actuator plates 51, 52, during each rotation of transmission unit 30. Such an arrangement therefore enables a relatively smooth transmission-ratio change to be effected with a relatively low force even where the conical members 11, 12 of the transmission unit have relatively steep conical angles, e.g., as required in bicycle transmissions.

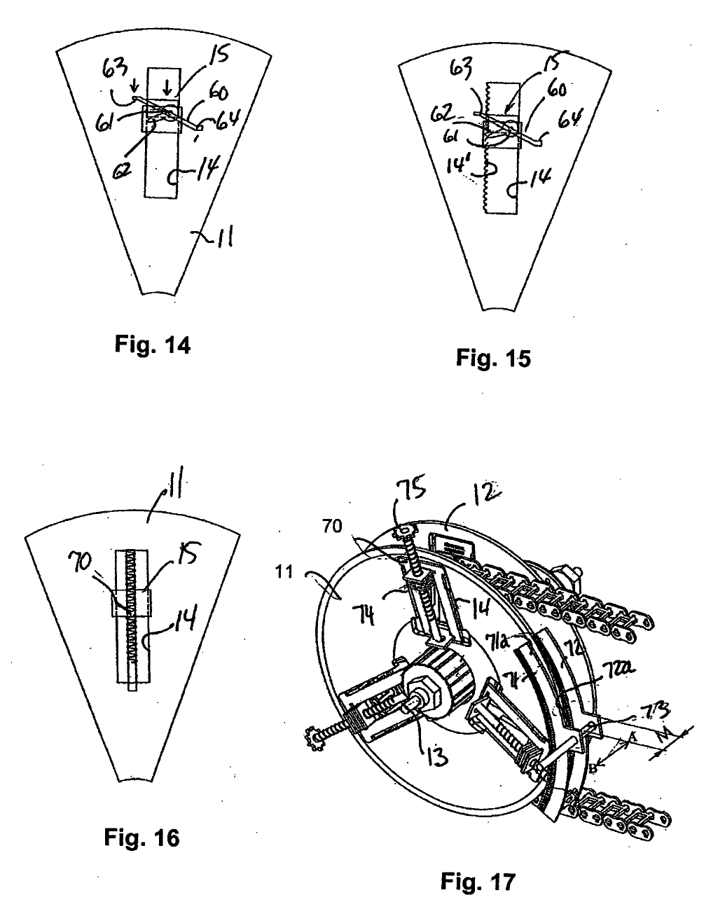

Preferably, the coupling elements 15 are locked in their radial positions in the respective transmission unit (10, 30) until a change in the transmission ratio is to be effected by mechanism 50. FIGS. 14 and 15 illustrate two such locking mechanisms that may be used for this purpose.

With reference first to FIG. 14, there is shown a coupling element 15 displaceable within radial slot 14 of the respective rotary member (e.g. 11, FIG. 1). Coupling element 15 includes a pivotal lever arm 60 pivotally mounted at an intermediate point 61 to coupling element 15 and integrally formed with a locking element 62 located such that the force applied by the link chain 20 on coupling element 15 firmly wedges locking element 62 within radial slot 14. The outer ends 63, 64 of lever arm 60 are located such that a force applied by either actuator plate 51, 52 of the ratio-changing mechanism 50 of FIG. 12, in the direction of pivotal axis 51 of lever arm 60, will pivot the lever arm to bring locking element 62 away from a wedging position with respect to radial slot 15, and will thereby release the coupling element for displacement within the radial slot.

During the normal operation of the transmission, when no change is to be made in the transmission ratio, the force applied by link chain 20 to each coupling element 15 will firmly wedge locking element 62 of the respective coupling element within radial slot 14 of the respective conical member 11. When a change is to be made by mechanism 50 in the transmission ratio, one of the actuator plates 51, 52 of mechanism 50 will first engage one of the outer ends 63, 64 of lever arm 60, such as to pivot the lever arm to release locking element 62 from its wedging condition within radial slot 14. This will permit the transmission-ratio changing mechanism to radially displace the respective coupling element 15 in the manner described above. If coupling element 15 is to be moved radially inwardly, mechanism 50 will first engage end 63 of lever arm 60 to release the coupling element for this movement; if the coupling element is to be moved radially outwardly, mechanism 50 will first engage end 64 of lever arm 60 to release the coupling element for this movement.

FIG. 15 illustrates a locking mechanism substantially the same as described above with respect to FIG. 14, except that in this case, the radial slots 14 are formed with grooved or serrated edges, as shown at 14′, to thereby provide a more positive locking action when engaged by locking element 62 of the respective coupling element 15.

FIG. 16 illustrates an arrangement wherein each coupling element 15 is held in its respective radial slot 14 by a threaded element which is rotated when the radial position of the coupling element is to be changed. Such a threaded element is schematically shown at 70 in FIG. 16, and an exemplary implementation is illustrated in FIG. 17.

Thus, as shown in FIG. 17, threaded element 70, which threadably displaces the coupling elements 15 within radial slots 14 of the two conical members 11, 12, is selectively actuated by a pair of actuator plates 71, 72, each carrying on its outer periphery a toothed segment 71a, 72a, respectively, at the unloaded side of the conical members. The two toothed segments 71a, 72a, are spaced apart a distance “M”. They are selectively movable together by the actuator bar 73 in the axial direction with respect to the rotary axis 13 of the two conical members 11, 12, i.e. either in the direction A or in the opposite direction B.

The coupling elements 15 are fixed to nuts 74 received on the respective threaded elements 70, such that rotation of its threaded element in one direction will move the coupling element 15 radially towards the rotary axis 13, whereas rotation of the threaded element in the opposite direction, will move its coupling element away from the rotary axis.

Each threaded element 70 carries, on its other end, a toothed wheel 75 of a diameter slightly smaller than the distance M and straddled on its opposite sides by the two toothed segments 71a, 72a.

Thus, during the normal rotation of the conical members 11, 12, toothed wheels 75 are not engaged by the toothed segments 71a, 72a. Coupling elements 15 carried by the nuts 74 on their respective threaded elements 70 thus remain in their respective radial positions, such that the transmission ratio between the two transmission units 10, 20 remains constant. When it is desired to change the transmission ratio, the actuator plates 71, 72 are moved by actuator bar in one direction A, or in the opposite direction B, to selectively engage one or the other of the opposite sides of the toothed wheels 75, and thereby to rotate their respective threaded elements 70, in one or the opposite direction, to change the radial position of their respective coupling elements 15 with respect to the link chain 20.

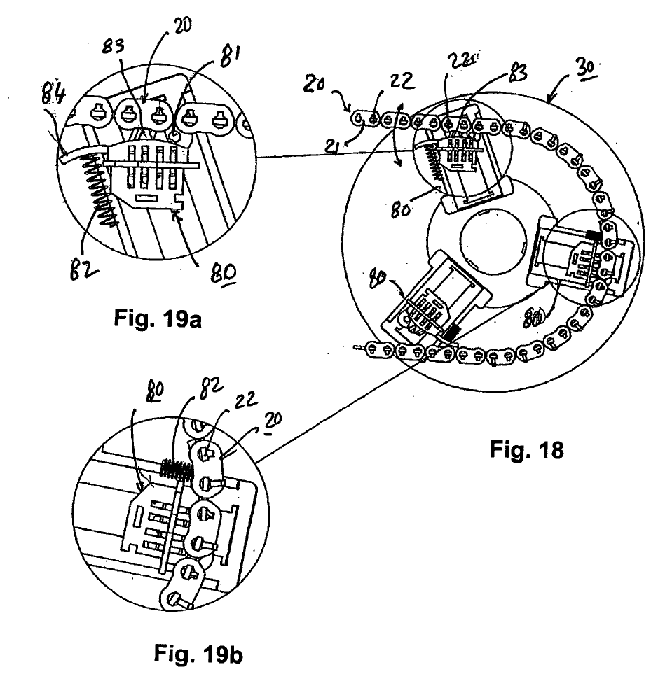

The Modifications of FIGS. 18-21b

One problem inherent to all variable transmission systems that rely upon a non-friction type engagement between a coupling element of an axle (e.g. teeth) and that of a driving element (e.g. links of a chain), results from an incorrect angle of approach during the engagement (which results from the stepwise engagement process) between the coupling elements of the axle and the driving element at a point of initial contact therebetween. In such systems, an engagement process may initiate prior to optimal alignment between the coupling element of the axle (e.g., teeth) and that of the driving element (e.g., link of a chain) thus resulting in premature or late engagement. The latter can lead to chain slackening or chain overtension which may in turn lead to noise, backlashes and jamming as well as more severe problems such as loss of power or chain breakage. In order to solve this problem the present inventor has devised a coupling alignment mechanism which ensures correct (optimal) alignment between the coupling elements of the axle and driving element. Although such a mechanism is described herein with respect to a chain type driving element, it will be appreciated that it can be readily adopted for use in any non-friction type variable transmission system, where the axis of the first transmission unit is generally perpendicular to the plane in which the second transmission unit moves including ones that employ belts, gears, rings and the like (examples of other types of variable transmissions that utilize this mechanism are provided in International Patent Application PCT/IL02/00075).

FIGS. 18-21b illustrate two arrangements which exemplify the coupling alignment mechanism of the present invention. In these illustrated arrangements, the coupling elements 15 of the respective transmission unit (in this case, 30) normally occupy an initial position with respect to second transmission unit 20 (link chain shown), but are movable to a coupling position in a way that enable precise engagement with the transversely-extending pins 22 of the link chain and as or after the link chain makes tangential contact with the effective coupling surface of the respective transmission unit.

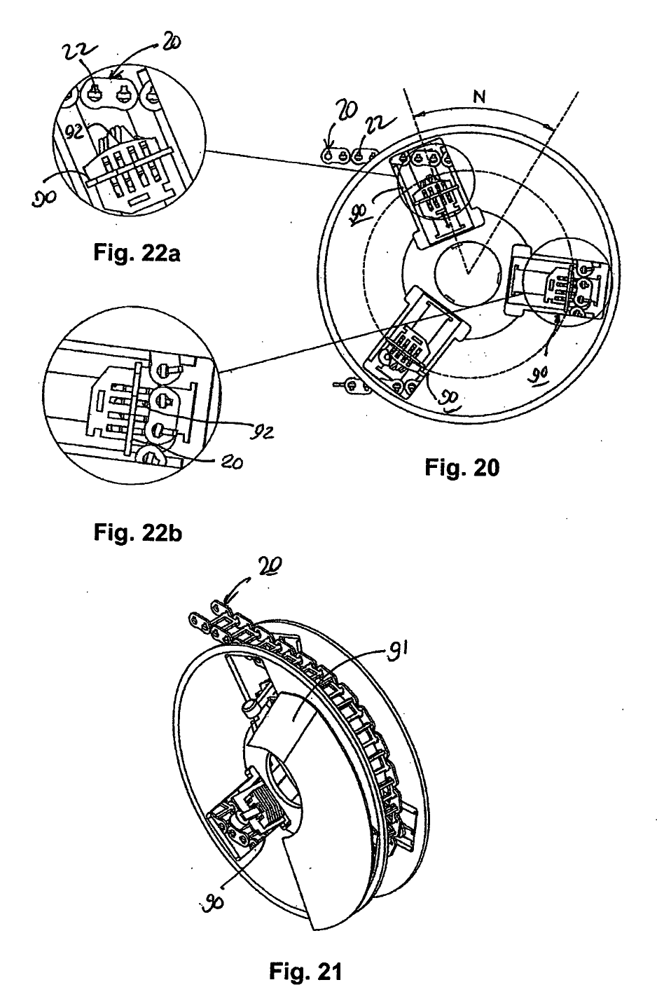

FIG. 18 illustrates an arrangement wherein the coupling elements of the respective transmission unit are pivotally mounted, and are pivoted from the initial position to the coupling position by the initial engagement of the coupling elements with the transversely-extending pins 22 of the link chain 20. FIG. 20 illustrates an arrangement wherein the coupling elements of the respective transmission unit are radially displaceable with respect to the transmission from the initial position in which they are spaced from the coupling surface of the transmission unit to a coupling position in engagement with the transversely-extending pins 22 of the link chain 20. In both cases, the coupling elements are movable from their initial positions to their coupling positions in engagement with the pins of the link chain, as or after the link chain makes tangential contact with the effective coupling surface of the transmission unit, thereby minimizing noise and the possibility of jamming at this initial contact.

In the arrangement illustrated in FIG. 18, each coupling element 80 includes a coupling alignment mechanism which, in FIG. 18, is implemented as pivot 81 (FIGS. 19a, 19b) which ensures that coupling element 80 is pivotally mounted to the respective transmission unit, and a spring 82 which functions in normally urging coupling element 80 to an initial position such that its teeth 83 are substantially perpendicular to the transversely-extending pin 22 of link chain 20 just upstream of the tangential point of contact of the link chain with the effective coupling surface defined by transmission unit 30.

As the link chain approaches the point of tangential contact with the effective coupling surface of transmission unit 30, its pin 22, engaging coupling element 80, pivots the pin, against the action of spring 82, so as to bring teeth 83 of the coupling element into precise alignment with the rotary axis of the transmission unit at the point of tangential contact of the link chain with the effective coupling surface of the transmission unit. This is schematically shown in FIG. 19b.

After the link chain has left the effective coupling surface of the transmission unit, spring 82 returns the coupling element 15 to its initial position, as illustrated in FIG. 19a, until the coupling element is again engaged by the link chain during the next rotation of the transmission unit.

Preferably, each coupling element 80 includes a cushioning leaf or spring, shown at 84, or a corresponding guiding element, for cushioning or guiding the return movement of each coupling element after leaving the link chain, to thereby reduce noise during the operation of the transmission system.

In the arrangement illustrated in FIG. 20, the coupling elements 90 are slightly inwardly from the path of the pins 22 in link chain 20 until the link chain engages the respective coupling element. In this case, the movement of each coupling element may be controlled, for example by a cam surface 91 (FIG. 21), such that normally the teeth 92 of the coupling elements 90 are spaced from the pins 22 of the link chain 20 as schematically shown in FIG. 22a.

The initial engagement of the link chain with the respective coupling element occurs within sector N of FIG. 20. Therefore, in section N, the respective coupling element 90 is moved outwardly to bring its teeth 92 into perpendicular engagement with the coupling pins 22 of the link chain 20 as or after the link chain tangentially engages the coupling surface of the transmission unit, as schematically shown in FIG. 22b.

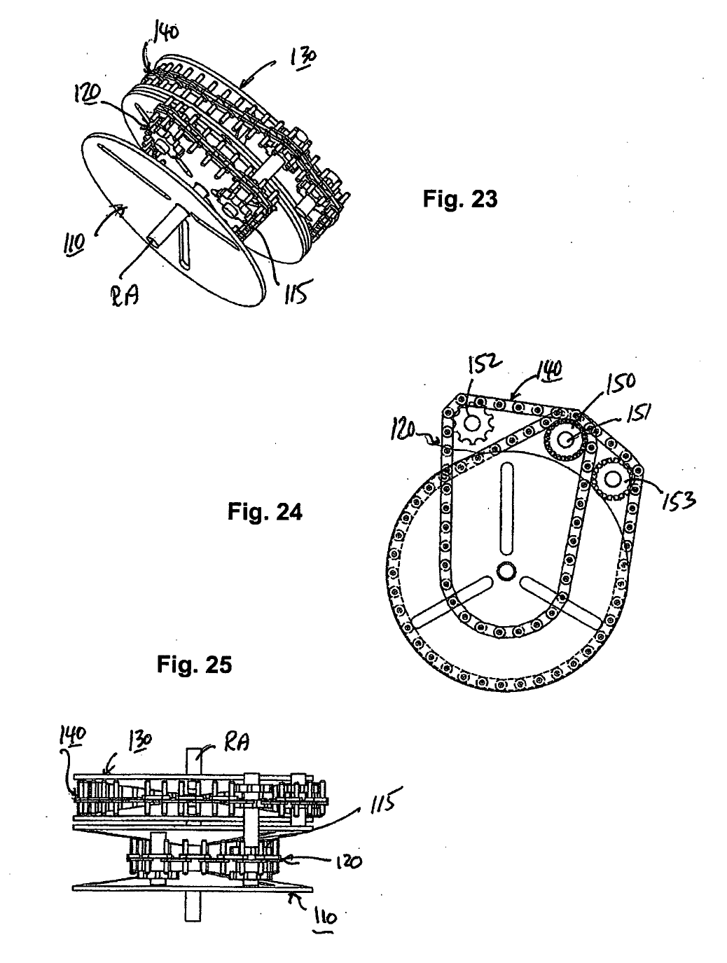

### The Embodiment of FIGS. 23-15

FIGS. 23-25 illustrate a continuously-variable transmission including two rotary transmission units, one serving as a driving unit and the other as a driven unit, mounted on a common rotary axis to thereby provide a very compact transmission system.

Thus, the transmission system illustrated in FIGS. 23-25 includes two rotary transmission units 110, 130, mounted for rotation on a common rotary axis RA. Each transmission unit 110, 130, is of the above-described construction, including a pair of axially-spaced rotary members, e.g. 111, 112, rotatable together about rotary axis RA. Each transmission unit further includes a plurality of coupling elements 115 radially displaceable with respect to the rotary axis RA to define an effective coupling surface of circular configuration having a diameter varying with the axial spacing between the rotary members. A first link chain 120 is wound around rotary transmission unit 110, and a second link chain 140 is wound around rotary transmission unit 130. As shown particularly in FIG. 24, the two link chains 120, 140, are coupled together via gearing 150 mounted on a common shaft 151.

The two rotary transmission units 110, 130, are free to rotate separately on the common axis RA, so that each may rotate at different speeds, and each may also change the axial spacing between the respective conical members independently of the other. It will be appreciated that when the coupling elements 115 of transmission unit 110 are radially displaced to decrease the diameter of the effective coupling surface, the coupling elements of the other transmission unit are radially displaced in the opposite direction, to increase the diameter of the effective coupling surface.

As shown in FIG. 24, the illustrated transmission further includes a pair of gears 152, 153, engageable with the link chains 120, 140, to maintain tension in the chains. Other tension-maintaining systems may be used, such as springs or the like.

It is possible to use a single link chain, rather than two as illustrated in FIGS. 23-25, but the link chain would then have to pass through a complicated path between the two rotary transmission units.

While the invention has been described with respective to several preferred embodiments, it will be appreciated that these are set forth merely for purposes of example, and that many variations and other applications of the invention may be made. For example, the first transmission unit could include coupling elements of fixed configuration, and the link chain could include coupling elements of a self-adaptive configuration.

Also, toothed surfaces, such as segments 71a, 71b and wheel 75, could be merely friction surfaces. Many other variations and applications of the invention will be apparent.

1. A continuously-variable transmission, comprising:
a first transmission unit including a rotary member rotatable about a rotary axis, and a plurality of circumferentially-spaced coupling elements carried by said rotary member and radially displaceable with respect to said rotary axis to define an effective coupling surface of circular configuration having a diameter varying with the radial positions of said coupling elements;
and a second transmission unit including a closed loop wound around said effective coupling surface of the first transmission unit and carrying a plurality of longitudinally-spaced coupling elements engageable with said coupling elements of the first transmission unit to effect a non-slip coupling therewith;
characterized in that said rotary member of the first transmission unit has an outer surface which is conical or substantially conical; and in that said closed loop of the second transmission unit further includes contact surfaces bearing against the outer conical surface of said first transmission unit where wound therearound for continuously supporting said closed loop in the circular configuration of the effective coupling surface of the first transmission unit.

2. The transmission according to claim 1, wherein said first transmission unit includes a pair of rotary members axially-spaced from each other and axially-displaceable towards and away from each other to vary the diameter of said effective coupling surface, each of said rotary members having an outer conical surface against which said contact surfaces of the closed loop of the second transmission unit bear for continuously supporting said closed loop in the circular configuration of the effective coupling surface of the first transmission unit.

3. The transmission according to claim 2, wherein said coupling elements of one of the transmission units are of a fixed configuration, and said coupling elements of the other of said transmission units are of a self-adaptive configuration, self-adaptive to the fixed configuration coupling elements of the first transmission unit in all radial positions of the coupling elements of the first transmission unit.

4. The transmission according to claim 3, wherein said coupling elements of the first transmission unit are of said self-adaptive configuration, and said coupling elements of the second transmission unit are of said fixed configuration.

5. The transmission according to claim 4, wherein said closed loop of the second transmission unit includes a link chain having plurality of links pivotally coupled together by a plurality of spaced, transversely-extending pins defining a plurality of alternating projections and depressions; said link chain including said contact surfaces of the second transmission unit engageable with said conical surfaces of the first transmission unit to support said link chain in said circular configuration where wound around the first transmission unit.

6. The transmission according to claim 5, wherein said links are located centrally of said link chain.

7. The transmission according to claim 5, wherein said links are located on the outer sides of said link chain.

8. The transmission according to claim 5, wherein said coupling elements of the first transmission unit include a pair of projections movable together in opposite directions to sequentially engage said pins of said link chain such as to effect a non-slip coupling therewith in all radial positions of the coupling elements of the first transmission unit.

9. The transmission according to claim 8, wherein each pair of projections of the first transmission unit is carried by a mounting plate mounted to and between said axially-spaced rotary members and radially displaceable thereon to define said effective coupling surface of circular configuration having a diameter varying with the spacing between the rotary members.

10. The transmission according to claim 9, wherein each of said mounting plates carries a plurality of pairs of projections movable together in opposite directions to sequentially engage said pins of said link chain such as to enhance the non-slip coupling in all radial positions of the coupling elements of said first transmission unit.

11. The transmission according to claim 9, wherein each of said mounting plates is formed with a pair of slots on each of its opposite ends slidably receiving the edges of the radially-extending slots formed in said axially-spaced rotary members.

12. The transmission according to claim 5, wherein said coupling elements of the first transmission unit include mounting plates mounted to and between said axially-spaced rotary members and radially displaceable thereon to define said effective coupling surface of circular configuration having a diameter varying with the spacing between the rotary members, each of said mounting plates including at least one tooth at one side, and at least one tooth on the opposite side non-aligned with the tooth on said one side, said mounting plate being axially movable with respect to said spaced rotary members to permit each pin in said link chain of the second transmission unit to sequentially engage said teeth of each mounting plate of said first transmission unit and to move said mounting plate axially and alternatingly in opposite directions in order to self-adapt the coupling elements of the first transmission unit to those of the second transmission unit.

13. The transmission according to claim 5, wherein the coupling elements of said first transmission unit are each carried on a mounting plate radially displaceable towards and away from said rotary axis to vary the diameter of said effective coupling surface; and wherein said transmission further includes actuator plates selectively actuatable to engage said mounting plates sequentially during the rotation of the first transmission unit, and to displace them radially towards or away from said rotary axis to thereby change the diameter of said effective coupling surface of said first transmission unit.

14. The transmission according to claim 13, wherein said actuator plates are located at the side of said first transmission unit opposite to that around which the closed loop of the second transmission unit is wound.

15. The transmission according to claim 13, wherein said actuator plates are spaced guide plates defining a guiding slot between them, the actuation of said actuator plates locating said guiding slot to sequentially receive extensions of said mounting plates during the rotation of said first transmission unit and thereby to displace said mounting plates radially towards or away from said rotary axis.

16. The transmission according to claim 15, wherein said guiding slot includes converging surfaces at its entry end for guiding the extensions of said mounting plates into said guiding slot.

17. The transmission according to claim 15, wherein said mounting plates including locking elements for normally locking the mounting plates in their respective slots of the first transmission unit, said locking elements being releasable by engagement with said guide plates at the entry end of said guiding slot.

18. The transmission according to claim 13, wherein said mounting plates of the first transmission unit are each carried by a threaded element which is rotatable to displace the mounting plate radially towards or away from the rotary axis according to the direction of rotation of the threaded element; said actuator plates having opposed surfaces selectively engageable with said threaded element of each mounting plate during the rotation of the first transmission unit, to selectively rotate the threaded elements, and thereby to displace the respective mounting plates towards or away from said rotary axis.

19. The transmission according to claim 5, wherein said coupling elements of the first transmission unit normally occupy an initial position with respect to said link chain, but are movable to a coupling position in precise engagement with the transversely-extending pins of the link chain, as or after the link chain makes tangential contact with said effective coupling surface of the first transmission unit.

20. The transmission according to claim 19, wherein said coupling elements of the first transmission unit are pivotally mounted from said initial position to said coupling position by the initial engagement with the transversely-extending pins of the link chain, and back to said initial position after disengagement from said pins of the link chain.

21. The transmission according to claim 20, wherein said coupling elements of the first transmission unit are carried by mounting plates mounted to and between said rotary members of the first transmission unit and radially displaceable to define said effective coupling surface of variable diameter; said mounting plates being pivotally mounted between said rotary members of the first transmission unit, and are spring-urged to return said coupling elements to said initial position.

22. The transmission according to claim 21, wherein each of said mounting plates further includes a cushion cushioning the return pivotal movement of the mounting plates and their respective coupling elements to their initial positions after the coupling elements have disengaged from the transversely-extending pins of the link chain.

23. The transmission according to claim 19, wherein said coupling elements of the first transmission unit are radially displaceable with respect to said first transmission unit from said initial position in which they are spaced from the effective coupling surface of the first transmission unit, to said coupling position in which they engage the transversely-extending pins of the link chain.

24. The transmission according to claim 23, wherein said coupling elements of the first transmission unit are carried by mounting plates mounted to and between said rotary members of the first transmission unit; said mounting plates being radially displaceable to define said effective coupling surface of variable diameter, said mounting plates being also radially displaceable to move said coupling elements thereof from said initial position to said coupling position with respect to the transversely-extending pins of the link chain, as or after the link chain has made tangential contact with said effective coupling surface of the first transmission unit.

25. The transmission according to claim 2, wherein said transmission further comprises; a third transmission unit coupled to first transmission unit by said second transmission unit; said third transmission unit being of the same construction as the first transmission unit to define an effective coupling surface also of circular configuration varying in diameter, but in the opposite direction, from that of said first transmission unit, such that when the diameter of the effective coupling surface of the first transmission unit increases, the diameter of the effective coupling surface of the second transmission unit decreases correspondingly.

26. The transmission according to claim 25, wherein said second transmission unit is wound on said first transmission unit and is coupled to said second transmission unit by a fourth transmission unit also in the form of a closed loop mounted on said third transmission unit and coupled thereto by a gearing system engageable with both said second and fourth transmission units.

27. A continuously-variable transmission, comprising:
a first transmission unit including a pair of axially-spaced rotary members rotatable together about a rotary axis, said rotary members being axially displaceable towards and away from each other, and carrying a plurality of circumferentially-spaced coupling elements radially displaceable with respect to said rotary axis to define an effective coupling surface having a diameter varying with the axial spacing between said rotary members;
and a second transmission unit carrying a plurality coupling elements engageable with said coupling elements of the first transmission unit to effect a non-slip coupling therewith;
characterized in that said coupling elements of the first transmission unit are each carried by a mounting plate radially displaceable towards and away from said rotary axis to vary the diameter of said effective coupling surface; and in that said first transmission unit further includes actuator plates selectively actuatable to engage said mounting plates sequentially during the rotation of the first transmission unit, and to displace them towards or away from said rotary axis to thereby change the diameter of said effective coupling surface of said first transmission unit.

28. The transmission according to claim 27, wherein said second transmission unit is coupled to one side of said first transmission unit; and wherein said actuator plates are located at the side of said first transmission unit opposite to that to which the second transmission unit is coupled.

29. The transmission according to claim 28, wherein said actuator plates are spaced guide plates defining a guiding slot between them, the actuation of said actuator plates locating said guiding slot to sequentially receive extensions of said mounting plates during the rotation of said first transmission unit to displace said mounting plates radially towards or away from said rotary axis.

30. The transmission according to claim 29, wherein said guiding slot includes converging surfaces at its entry end for guiding the extensions of said mounting plates into said guiding slot.

31. The transmission according to claim 29, wherein said mounting plates including locking elements for normally locking the mounting plates in their respective slots of the first transmission unit, said locking elements being releasable by engagement with said guide plates at the entry end of said guiding slot.

32. The transmission according to claim 27, wherein said mounting plates of the first transmission unit are each carried by a threaded element which is rotatable to displace the mounting plate towards or away from the rotary axis according to the direction of rotation of the threaded element; said actuator plates having opposed surfaces selectively engageable with said threaded element of each mounting plate during the rotation of the first transmission unit, to selectively rotate the threaded elements, and thereby to displace the respective mounting plates towards or away from said rotary axis.

33. The transmission according to claim 27, wherein said pair of axially-spaced rotary members of the first transmission unit have outer conical surfaces; and wherein said second transmission unit includes a closed loop having contact surfaces engageable with the outer conical surfaces of said first transmission unit for supporting said closed loop in the circular configuration of the effective coupling surface of the first transmission unit.

34. The transmission according to claim 33, wherein said coupling elements of one of the transmission unit are of a fixed configuration, and said coupling elements of the other of said transmission units are of a self-adaptive configuration, self-adaptive to the fixed configuration coupling elements in all radial positions of the coupling elements of the first transmission unit.

35. The transmission according to claim 34, wherein said coupling elements of the first transmission unit are of said self-adaptive configuration, and said coupling elements of the second transmission unit are of said fixed configuration.

36. The transmission according to claim 35, wherein said closed loop of the second transmission unit is a link chain having a plurality of links pivotally connected together by a plurality of pins.

37. A transmission, comprising:
a first transmission unit including a rotary member rotatable about a rotary axis and having a plurality of circumferentially-spaced coupling elements carried thereby to define an effective coupling surface of circular configuration;
and a second transmission unit including a closed loop link chain wound around said rotary member and having a plurality of transversely-extending pins engageable with said coupling elements of the rotary member to effect a non-slip coupling therewith;
said coupling elements of the rotary member being movably mounted thereon so as to occupy an initial position with respect to said link chain, but movable to a coupling position in precise alignment with the transversely-extending pins of the link chain, as or after the link chain makes tangential contact with said effective coupling surface of the first transmission unit.

38. The transmission according to claim 37, wherein said coupling elements of the first transmission unit are pivotally mounted for movement from said initial position to said coupling position by the initial engagement with the transversely-extending pins of the link chain, and back to said initial position after disengagement from said pins of the link chain.

39. The transmission according to claim 37, wherein said coupling elements of the first transmission unit are radially displaceable with respect to said first transmission unit from said initial position, in which they are spaced from the effective coupling surface of the first transmission unit, to said coupling position in which they engage the transversely-extending pins of the link chain.

40. The transmission according to claim 37, wherein said coupling elements of the first transmission unit are displaced as a result of the pressure of said second transmission unit on a part of said coupling elements.

41. The transmission according to claim 37, wherein said coupling elements of the first transmission unit are displaced as a result of the pressure of a stationary member on said coupling elements due to the rotation of said first transmission unit.

42. The transmission according to claim 37, wherein said first transmission unit includes a pair of rotary members axially-spaced from each other and axially-displaceable towards and away from each other to vary the diameter of said effective coupling surface, each of said rotary members having an outer conical surface against which said contact surfaces of the closed loop of the second transmission unit bear for continuously supporting said closed loop in the circular configuration of the effective coupling surface of the first transmission unit.

43. A transmission, comprising:
A first transmission unit including a plurality of circumferentially-spaced coupling elements defining an effective coupling surface;
a second transmission unit engageable with first transmission unit to enable non-slip coupling therewith; and
a coupling alignment mechanism being for controlling an engagement between each of said coupling elements and said second transmission unit so as to ensure proper engagement at an initial point of contact therebetween.

44. The transmission according to claim 43, wherein said coupling alignment mechanism includes pivotal mounting of said coupling elements of said first transmission, such that said coupling elements are capable of repeatedly rotating from a first position to a second position.

45. The transmission according to claim 43, wherein said coupling alignment mechanism enables repeated radial displacement of said coupling element from a first and non-engaging position to a second and engaging position.

46. The transmission according to claim 44, wherein said coupling alignment mechanism is configured such that said coupling elements are rotated or radially displaced as a result of the pressure of said second transmission unit on a part of said coupling elements.
